(19) United States
(12) Patent Application Publication
(10) Pub. No.: US 2010/0284842 A1
(43) Pub. Date: Nov. 11, 2010

(54) Method of producing a stator segment for a segmented stator of an eccentric screw pump

(76) Inventor: Sebastian Jager, Hannover (DE)

Correspondence Address: ROBERT W. BECKER & ASSOCIATES, 707 HIGHWAY 333, SUITE B, TIJERAS, NM, 87059-7507, US

(21) Appl. No.: 12/435,838

(22) Filed: May 5, 2009

(51) Int. Cl. F01C 1/10; F01C 5/04; F04C 2/107; B23P 15/00

(52) U.S. Cl. 418/48; 418/153; 418/220; 29/888.023

(57) ABSTRACT

A method for producing a stator segment for a segmented stator of an eccentric screw pump or an eccentric screw motor, as well as a stator segment and a stator. A stator segment in an initial state is processed or machined with a linear cutter that removes material to provide the stator segment with a helical inner segment surface.

The present invention relates to a method of producing a stator segment for a stator composed of segments, i.e. a segmented stator, of an eccentric screw pump or an eccentric screw motor, and also relates to a stator segment and a stator.

Eccentric screw pumps and eccentric screw motors that operate according to the Moineau principle are fundamentally known. Such pumps and motors generally include a stator and a rotor disposed in the interior of the stator. The stator includes a stator tube made of a relatively hard material, and an elastomeric lining that is connected to the inner surface of the stator tube. In this connection, the lining is formed in the manner of a multiple, helical coarse thread and forms a hollow chamber in which is received the rigid rotor, which is also formed in the manner of a helical coarse thread, whereby the rotor has one fewer thread than does the stator.

A stator for an eccentric screw pump or an eccentric screw motor that operates pursuant to the Moineau principle is disclosed in U.S. Pat. No. 7,396,220 B2. The stator includes a plurality of stator segments that are axially disposed one after the other. Each stator segment has a helical inner segment surface, whereby in the combined state the individual inner segment surfaces of the stator segments complete a helical inner stator surface. The stator additionally includes an elastomeric lining which covers the inner stator surface, which is comprised of the individual helical inner segment surfaces, with a uniform layer thickness. For the fixation of the individual stator segments in their position, the stator segments are connected in a frictionally tight manner with an outer tube that surrounds the stator segments. The orientation of the stators relative to one another is ensured by pins that respectively engage in an interlocking manner in two adjacent stator segments to prevent rotation of the adjacent stator segments relative to one another. An alternative for fixating the individual stator segments is the formation of one or more axially extending grooves in an outer tube that surrounds the stator segments, with projections of the stator segments engaging in an interlocking manner in the grooves. A movement of the stator segments in an axial direction is guarded against by a front and rear screw connection. The individual stator segments are produced by a casting process. Aluminum is used as the material. A stator segment preferably has an axial extension of 150 to 600 mm.

A drawback of producing a stator segment by means of a casting process is that for each stator segment having a different inner segment surface a new casting mold is required.

It is an object of the present invention to provide a variable method for production of a stator segment for a segmented stator of an eccentric screw pump or an eccentric screw motor, as well as a stator segment and a stator.

These objects are realized by a method, a stator segment, and a stator pursuant to the independent claims.

Advantageous further developments are the subject matter of the dependent claims.

Pursuant to the method of the present invention, a stator segment that is in an initial state is processed with a linear cutting means that removes material to produce a helical inner segment surface. The removal of the material by cutting means can, for example, be effected in a machining, abrasive or ablating manner. As a linear cutting means, preferably a beam or jet, for example a water jet, a laser beam or a plasma beam, or a filament, for example a fuse wire or a spark erosion wire, are used. By using a material-removing cutting means, the method is very variable. The production of a further stator segment having a different inner segment surface generally requires only an alteration of the control of the cutting means. Further tools or tool components are not required.

By means of the method it is possible in particular to also produce helical inner segment surfaces having a high number of threads. No reworking or finishing of the inner segment surface is required. In addition to a single cutting means, a plurality of cutting means can also be used in parallel.

The term “helical” preferably also includes surfaces that approximate a helical shape.

The orientation and the movement of the cutting means is provided in an advantageous further development in that the cutting means enters at an outer edge of the helical inner segment surface that is to be produced, and exits a second outer edge of the helical inner segment surface that is to be produced, whereby the path of the cutting means follows the helical inner segment surface that is to be produced and that is defined by the first outer edge and the second outer edge. In this manner, the cutting means is moved along two closed or continuous lines, the first outer edge and the second outer edge, and in this connection is rotated and pivoted, if necessary. It is not necessary to interrupt the cutting means.

A plurality of stator segments produced in this manner can be joined together to form a stator. A stator can, for example, be embodied as a stator of an eccentric screw pump or an eccentric screw motor that operates according to the Moineau principle. The helical inner surface of the stator comprised of the individual inner segment surfaces of the stator segments is preferably coated with a lining made of an elastomeric material, preferably a rubber having an essentially uniform layer thickness.

The invention will be subsequently explained in greater detail with the aid of an embodiment that is illustrated by several figures, in which:

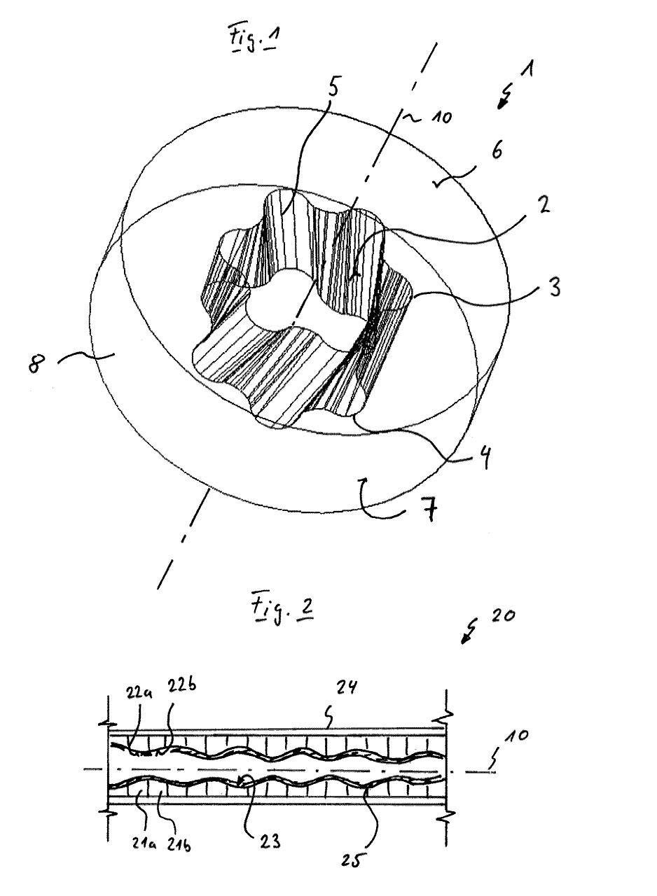

FIG. 1 is a perspective view of one exemplary embodiment of an inventive stator segment that is produced via one embodiment of an inventive method for producing a stator segment; and

FIG. 2 is a longitudinal cross-sectional view through a portion of an embodiment of an inventive stator.

FIG. 1 shows one exemplary embodiment of an inventive stator setment 1 for a stator composed of segments, i.e. a segmented stator, of an eccentric screw pump or an eccentric screw motor.

The stator segment 1 has a disk-shaped configuration. It includes a planar first base 6, which is oriented perpendicular to a central axis 10, and a planar second base 7, which is oriented parallel to the first base 6. Disposed between the bases 6, 7 is a cylindrical outer surface 8. The axial extension of the stator segment 1 is at most 100 mm. The stator segment 1 is made of metal, in this case aluminum.

Alternatively, the stator segment 1 can, for example, also be made of ceramic or a cross-linked or thermoplastic polymer.

The stator segment 1 has a helical inner segment surface 2 that extends about the axis 10. The helical inner segment surface 2 is delimited by a first closed or continuous outer edge 3 and a second closed or continuous outer edge 4. The first outer edge 3 is the inner edge of the first base 6, and the second outer edge 4 is the inner edge of the second base 7. The inner segment surface 2 is configured in such a way that it can be comprised of straight lines 5 that extend from the first outer edge 3 to the second outer edge 4. A plurality of such straight lines 5 is illustrated in FIG. 1 by way of example.

The helical inner segment surface 2 approximates an ideal helical shape. The deviation from the ideal shape due to the approximation of straight lines extending from the first outer edge 3 to the second outer edge 4 is a function in particular of the axial extension of the stator segment 1. By reducing the axial extension, the approximation to the ideal helical shape can be improved.

Pursuant to one embodiment of an inventive method for producing such a stator segment 1, a stator segment that is in an initial state is processed or machined with a material-removing beam or jet for the production of the helical inner segment surface 2. The stator segment, which is in the initial state and which is not illustrated, is a disk-shaped solid material having a planar first base and a second base that extends in a planar and parallel manner relative to the first base, as well as a cylindrical outer surface 8 that is disposed between the first base and the second base. The axial extension of the stator element that is in the initial state corresponds to the axial extension of the processed stator segment 1.

Alternatively, instead of being made of a solid material, the stator segment in the initial state can, for example, be provided with a hole or a bore.

By means of a (not shown) beam or jet, cut out of the stator segment that is in the initial state is an inner segment piece having an inner piece outer surface that is complementary to the helical inner segment surface 2. The inner segment piece (not shown) is removed from the processed stator segment 1, for example by turning out or alternative measures that are known per se.

For the cutting out of the inner segment piece, the beam is oriented and moved in such a way that the beam enters the material on the first outer edge 3 of the helical inner segment surface 2 that is to be produced, and exits the material on the second outer rim 4 that delimits the helical inner segment surface 2, whereby the path of the beam follows the helical inner segment surface 2 that is to be produced. The straight lines 5 illustrated in FIG. 1 between the first outer edge 3 and the second outer edge 4 represent this orientation and movement of the beam by way of example. In principle, it is in this way possible to form the helical inner segment surface 2 merely by moving the beam along the first outer edge 3 and the second outer edge 4, which is preferred pursuant to the invention. In this case, the beam does not have to be interrupted. Furthermore, the mass of the material that is to be removed for the cutting out of the inner segment piece is minimized.

As a beam for the removal of the material, a water jet that is as concentrated or point-type as possible is used and to which an abrasive material is added. Alternative beam methods are also possible, such as a laser beam process or plasma cutting processes. Furthermore, a plurality of beams or jets can be used in parallel.

The control of such a beam is carried out as follows:

The objective is to produce an inner segment surface 2 that can be described by a helical screwing of a cross-sectional area that corresponds to a hypocycloid or preferably an epihypocycloid. For this purpose, the beam is moved over the outer edge 3 along the hypocycloidal cross-sectional contour. By means of linear, rotational and pivotal movements along or about at least three axes of movement, a different beam direction vector can be associated with each point along the inner segment surface 2 that is to be produced, and in this manner the ideal helical shape can be approximated. For the production of the inner segment surface 2, the beam is preferably moved not only linearly along two axes that are linearly independent of one another and that lie in a plane oriented perpendicular to the axis 10, but are also rotated or pivoted about two rotational axes that in this plane are disposed perpendicular to one another.

The control is preferably effected automatically, aided by a computer.

Instead of the use of a beam as a material-removing linear cutting means, it is possible for this purpose to also alternatively use a linearly stretched filament, for example a spark erosion wire or a fuse wire. The processing of the stator segment 1 for the production of the inner segment surface 2 by means of spark erosion is, for example, suitable for a stator segment 1 made of metal, and by means of melting or fusing is, for example, suitable for a plastic stator segment 1. The orientation and the movement of the filament is effected, as with the beam process described above, along the straight lines 5 illustrated by way of example in FIG. 1.

FIG. 2 shows a longitudinal section through a portion of an exemplary embodiment of an inventive segmented stator 20.

The stator 20 includes a plurality of stator segments 21a, 21b, which are disposed axially one after the other along the axis 10 for the formation of a helical inner stator surface 23. Individual stator segments 21a, 21b are in principle formed as is the stator segment 1 illustrated in FIG. 1. The inner segment surface 2 varies from stator segment to stator segment in order to complete the helical inner stator surface 23.

In order to fix the position of the joined-together stator segments 21a, 21b, the stator 20 includes an outer tube 24. The stator segments 21a, 21b are disposed within the outer tube 24, and are secured against a movement in the axial direction and against carrying out a rotational movement relative to adjacent stator segments, for example by means of a frictionally tight connection, a form-fitting connection, or some other positive connection. Such measures are known. For example, in this regard reference is made to the disclosure of U.S. Pat. No. 7,396,220 B2.

Alternatively, or in combination, a fixation of the stator segments 21a, 21b via compression or deformation of the outer tube 24 is possible. For this purpose, the stator segments 21a, 21b are disposed within the outer tube 24, whereby the inner diameter of the outer tube is greater than the outer diameter of the stator segments 21a, 21b. In a subsequent step, the outer tube 24 is radially compressed or deformed until a sufficient fixation of the stator segments 21a, 21b is provided.

The stator 20 additionally includes a lining 25 that is made of an elastomeric material, here a rubber, and which is applied to the helical inner stator surface 23 that is formed by the individual stator segments 21a, 21b. The lining 25 has an essentially uniform thickness.

1-15. (canceled)

16. A method for producing a stator segment for a segmented stator of an eccentric screw pump or an eccentric screw motor, including the steps of:
providing a stator segment that is in an initial state, and processing the stator segment that is in an initial state with a linear cutting means that removes material to provide the stator segment with a helical inner segment surface

17. A method according to claim 16, which includes the further step of moving the linear cutting means along a continuous line that extends on the helical inner segment surface that is to be produced.

18. A method according to claim 16, wherein the linear cutting means is oriented in such a way that a path of the cutting means is disposed on the helical inner segment surface that is to be produced.

19. A method according to claim 16, which includes the further step of moving the cutting means in such a way that a path of the cutting means follows the helical inner segment surface that is to be produced.

20. A method according to claim 18, which includes the further step of cutting an inner segment piece out of the stator segment that is in an initial state by means of the cutting means, wherein the inner segment piece has an outer surface that is complementary to the helical inner segment surface.

21. A method according to claim 16, wherein the stator segment that is in an initial state is a disk having a planar first base and a second base that extends in a planar and parallel manner relative to the first base.

22. A method according to claim 16, wherein the stator segment that is in an initial state has a closed outer surface.

23. A method according to claim 16, wherein the stator segment that is in an initial state has an axial extension of at most 100 mm.

24. A method according to claim 16, wherein the stator segment that is in an initial state is made of metal, preferably aluminum, or of ceramic or of a cross-linked or thermoplastic polymer.

25. A method according to claim 16, wherein the cutting means is a beam or jet, preferably a water jet, a laser beam or a plasma beam, or a filament, preferably a spark erosion wire or use wire.

26. A method according to claim 16, wherein said processing step, for the production of the helical inner segment surface, includes the steps of linearly moving the cutting means at the least along two axes that are linearly independent of one another, and rotating the cutting means at least about one axis of rotation.

27. A method according to claim 16, wherein said processing step by means of the cutting means produces a helical inner segment surface having a hypocycloid, preferably an epihypocycloid, cross-sectional area.

28. A stator segment for a segmented stator of an eccentric screw pump or an eccentric screw motor, wherein said stator segment has a helical inner segment surface that is delimited by a first continuous outer edge and a second continuous outer edge, wherein said outer edges are provided on opposite sides of said stator segment, and wherein said inner segment surface is comprised of straight lines that extend from said first outer edge to said second outer edge.

29. A stator segment according to claim 28, wherein said stator segment has a disk-shaped configuration with a planar first base, which is oriented perpendicular to an axis of said stator segment, a planar second base which is oriented parallel to said first base, and an outer surface that is disposed between said first and second bases.

30. A stator comprised of a plurality of the stator segments wherein said stator segments are disposed axially one after the other to form a helical inner stator surface.
